(19) United States
(12) Patent Application Publication
(10) Pub. No.: US 2017/0085613 A1
(43) Pub. Date: Mar. 23, 2017

(54) METHOD AND SYSTEM FOR TRANSFERING AND INTERACTING WITH MEDIA FROM A DEVICE

(71) Applicant: Mario Reyes, Providence, RI (US)

(72) Inventor: Mario Reyes, Providence, RI (US)

(21) Appl. No.: 15/267,217

(22) Filed: Sep. 16, 2016

Related U.S. Application Data
(60) Provisional application No. 62/222,510, filed on Sep. 23, 2015.

(51) Int. Cl. H04L 29/06; H04W 4/00

(52) U.S. Cl. CPC H04L 65/601; H04W 4/001; H04L 65/4076

(57) ABSTRACT

The disclosed herein is an internet radio system implemented over the internet. The system comprises of a media server having at least user access data storage, file storage, and a first network interface for communicating with said internet; a wireless portable internet radio device having at least a display screen, a first user input device, a second network interface for communicating with the media server via said internet; and a first audio transducer for recording a first audio input, and a first encoder/decoder for converting said first audio input into a first audio file for streaming to said media server, wherein said streaming occurs contemporaneously with said first audio input being recorded by said first audio transducer.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates generally to entertainment systems, and relates more particularly to interne radio and karaoke systems.

(2) Background

Radio is a very popular entertainment source today. It is used in many locations—in the home, in the automobile, at the office, and on the go. Sources available today include broadcast (AM and FM), Internet, and satellite. However, radio functions have been fairly constant for years.

New technologies have become available in recent years. These include less expensive tuners, less expensive memory, and better quality analog to digital conversion. These technologies make possible an enhanced radio system.

Some improvements have been made in television systems recently. Personal video recorders, such as those manufactured by TiVo, allow a user to easily record a television program, and also provide VCR-like controls for television programs. For example, one prior art display pause with elastic playback, another prior art provides a method and apparatus implementing random access and time-based functions on a continuous stream of formatted digital data, and technology exists for multimedia time warping. However, these types of improvements have been optimized for the needs of the television viewer. For instance, this prior art focuses on improving the viewing of specific television programs.

Radio listeners typically have different needs than television viewers. For example, television viewing typically happens in a fixed environment in a home, while radio listening often happens in varied, often mobile, environments. People may listen to the radio in a shower. People often listen to radio in a car, or carry a radio on their person as they pursue other activities. A television viewer may sit and watch a program through its completion. A radio listener more often listens casually while pursuing other activities, and may often switch between stations based on hearing a short duration item, such as a song, commercial, or traffic/weather report. Program schedules are quire important to television viewers, but are rarely used by radio listeners.

Traditionally, in order to broadcast an internet radio stream to an audience, a microphone or audio recording device maybe utilized to record audio to a laptop or desktop computer. Once the audio has been recorded, an encoder program in the laptop or desktop computer then converts the audio file into a streaming format. Once the audio file has been converted to a streaming format, the audio stream would then be sent to a broadcasting server via the Internet. The broadcasting server would then transmit the audio stream over the Internet to enable subscribing listeners, who can then receive and play the audio stream via their computer's player.

Consider the situation wherein, for example, manager A of Corporation ABC wants to broadcast a training seminar to Corporation ABC's employees through his corporate private internet radio station. Manager A is currently driving for three hours to a meeting and wants to utilize this time to conduct the training seminar. Manager A, having no laptops or computers available during his drive, would first record the training seminar audio on to a handheld digital voice recorder, for example.

Once manager A has arrived at his destination, manager A would then connect his handheld digital voice recorder to his laptop and upload the recorded training seminar to the laptop. Once the recorded training seminar has been uploaded to the laptop, an encoder in the laptop then converts the audio file into a streaming format in order for the audio to be able to be sent via the Internet to a broadcasting server. Once the audio stream has been received by the broadcasting server, the broadcasting server transmits the audio stream over the Internet to enable the subscribing employees of Corporation ABC to receive and play the training seminar via their computer's player.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates a prospective view of the invention identifying the different components of the invention and their working.

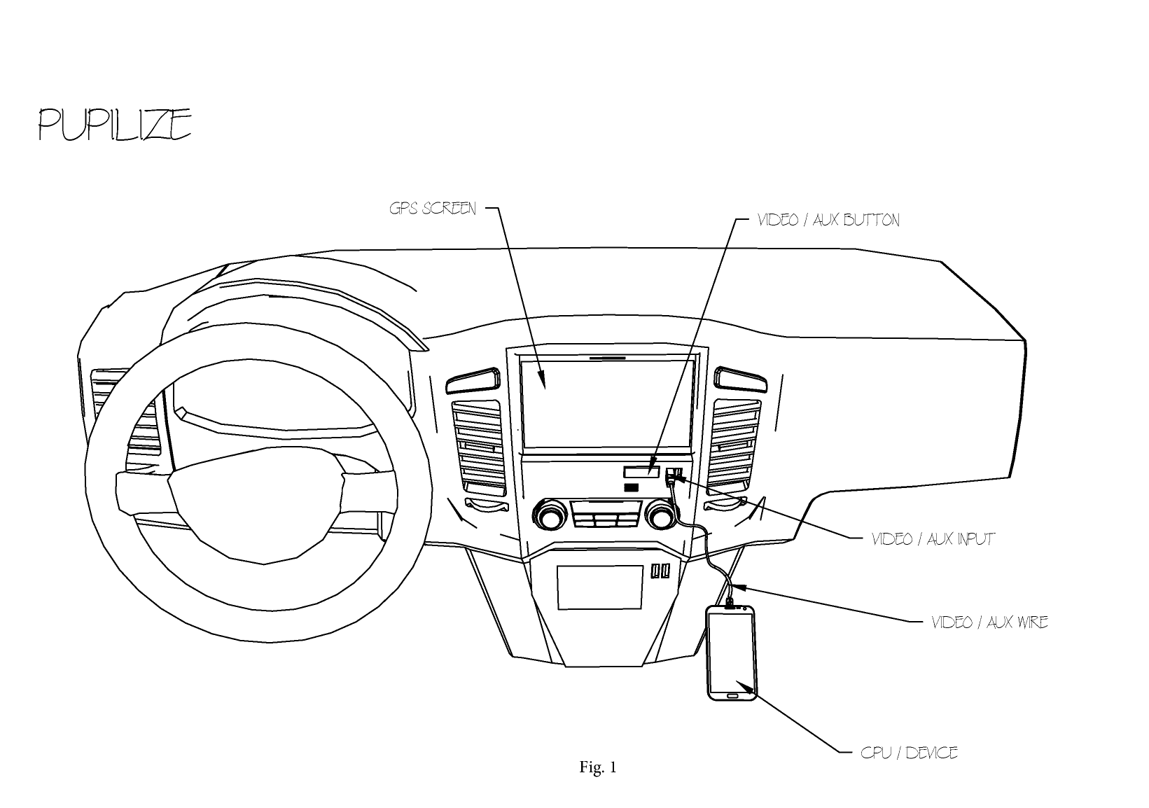

### BRIEF SUMMARY OF THE INVENTION

By way of introduction, the embodiments described below provide methods for playing digital media files with a digital media player using a plurality of playlists. In a preferred embodiment the invention is an internet radio system implemented over the internet. The system comprises of a media server having at least user access data storage, file storage, and a first network interface for communicating with said internet; a wireless portable internet radio device having at least a display screen, a first user input device, a second network interface for communicating with the media server via said internet; and a first audio transducer for recording a first audio input, and a first encoder/decoder for converting said first audio input into a first audio file for streaming to said media server, wherein said streaming occurs contemporaneously with said first audio input being recorded by said first audio transducer.

Further in a preferred embodiment the wireless portable internet radio device of the internet radio system comprises of a non-transitory computer readable storage medium configured to store a plurality of instances of digital media files and a plurality of playlists, wherein each playlist specifies a predetermined play order of at least some of the plurality of digital media files, and wherein at least one playlist in the plurality of playlists specifies at least one digital media file that is not specified by another playlist in the plurality of playlists and at least one processor configured to cause a user interface to be displayed on the display and further configured to respond to inputs to the user interface.

In yet another embodiment the internet radio system implemented over the internet performing said plurality of playlists in an offline mode comprises of selecting a first playlist from the plurality of playlists, playing the digital media files specified in the first playlist and selecting a second playlist thereafter from the plurality of playlists to play the digital media files specified in the second playlist.

The user interface of the internet radio system implemented includes at least one first user interface element configured to enable a user to select a collection of instances of media available, the collections include predefined genres and/or musical themes and the collections further include playlists.

Also the system comprising a queue jumping module configured to enable the user to move a selected instance of media to a user-specified location in the queue and provides a means to connect the system to another electronic device via an auxiliary cable to transfer and display the media files stored in the wireless portable internet radio device. The system provides a set of recommended radio stations from information about available radio stations and a means to select a radio station from the set of recommended radio stations via the user interface. Further the system provide user access data storage that is configured for storing user access credentials

The system may also provide a karaoke mode. In this mode, it may remove the vocal component from the audio signal as it is being played. It may also display lyrics of a song as it is being played. Further the system provides saving karaoke music videos on SD card to use without being online and a video aux can be used to display videos on the GPS screens of a car.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### DETAILED DESCRIPTIONS OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar 21, 2006); (3) U.S. patent application Ser. No 08/210,610 (“Computer system with touchpad support in operating system”, filed Mar. 18, 1994); (4) U.S. patent application No. 10/643,256(“Movable touch pad with added functionality”, filed ______), touch screens such as those described in(but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006, keyboards, such as those mentioned in (but not limited to) U.S. patent application number 07/711,760 (“Ergonomic keyboard input device”, filed on Jun. 6, 1991), mouse, such as those described in (but not limited to) (1) U.S. application Ser. No. (“Computer mouse with enhance control button (s)”, filed on Oct. 6, 1998); (2) U.S. application Ser. No. 08/288,945 (“Roller mouse for implementing scrolling in windows applications”, filed on Aug. 10, 1994) and gesture recognition means, such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices.

Connectivity of these devices with networks, such as the internet, an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document.

The present invention maybe implemented on applications that run on a single or variety of operating system platforms, including but not limited to OS X, WINDOWS, UNIX, IOS, ANDROID, SYMBIAN, LINUX, or embedded operating systems, such as VxWorks.

The invention has FM mode to play there music audio from a wireless portable internet radio device to any old car radios, house radios, that's without the aux switch option and Bluetooth option the consumers would put the fm transmitter mode on, in settings and then the consumer would be told to put on a radio station number on the radio device of the cars, or radios for house or portable radios then press play on your music song on your cpu device and then you will hear your music from your old car, or other radio deck player without aux or Bluetooth option.

Alternatively, the system may acquire the lyrics separately using communications device. The system may indicate the availability of the karaoke feature to the user when the incoming radio signal supports it, for example on display device. The system may allow the user to select karaoke mode, for example with user controls. The karaoke mode would be used by using the same closed captions mode for deaf people on TV but the normal black & white caption words that's on the TV would be in colors and the letters music note size would be bigger for the singer to see the lyrics of the song. The system could play any music videos or just audio without a editor for the lyrics of the song to show on TV screen and the video aux wire would be use from the device to use for any TV screen, for clubs, bars, house, cars for karaoke without the old karaoke machine that's use today. Consumers who sign onto there username account would change there playing mode in settings to karaoke mode and when the username plays there music videos or audio the lyrics would show up on there device to any TV screen device with video aux wire.

Another feature of the system is language mode that would be turn on in username settings by username and choose any country to translate music video songs being played to the consumers around the world that who don't know the language of the music artist songs they're listening too by using the language mode closed captions would be seen atomically on TV screen of car, any tv screen for the consumer to know what the music artist is saying through video aux plug in and video aux wire.

The invention provides a convenient system to the consumer to listen and see the music by using video aux wire to video aux input all in one app without going online. The system provides rewinding music or fast forwarding the music while the music artist audio songs is auto dj playing from your library station. Also, the system provides saving karaoke music videos on SD card to use without being online and a video aux can be used to display videos on the GPS screens of a car.

The system comprising a queue jumping module configured to enable the user to move a selected instance of media to a user-specified location in the queue and provides a means to connect the system to another electronic device via an auxiliary cable to transfer and display the media files stored in the wireless portable internet radio device. The system provides a set of recommended radio stations from information about available radio stations and a means to select a radio station from the set of recommended radio stations via the user interface. Further the system provide user access data storage that is configured for storing user access credentials.

The invention is an internet radio system implemented over the internet. The system comprises of a media server having at least user access data storage, file storage, and a first network interface for communicating with said internet; a wireless portable internet radio device having at least a display screen, a first user input device, a second network interface for communicating with the media server via said internet; and a first audio transducer for recording a first audio input, and a first encoder/decoder for converting said first audio input into a first audio file for streaming to said media server, wherein said streaming occurs contemporaneously with said first audio input being recorded by said first audio transducer. And in a preferred embodiment the wireless portable internet radio device of the internet radio system comprises of a non-transitory computer readable storage medium configured to store a plurality of instances of digital media files and a plurality of playlists, wherein each playlist specifies a predetermined play order of at least some of the plurality of digital media files, and wherein at least one playlist in the plurality of playlists specifies at least one digital media file that is not specified by another playlist in the plurality of playlists and at least one processor configured to cause a user interface to be displayed on the display and further configured to respond to inputs to the user interface.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A method for transferring and interacting with media from one device to another, the method comprising:
accessing, by one or more processors, media on a first device;
connecting, by one or more processors, the first device with a second device;
transferring, by one or more processors, the media from the first device to the second device;
modifying, by one or more processors, the media on the second device; and
playing, by one or more processor, the media through an output of the second device.

2. The method of claim 1, further comprising:
responsive to accessing the media on the first device, altering, by one or more processors, the order of the media.

3. The method of claim 1, wherein modifying the media on the second device includes separating, by one or more processors, the audio from the video of the media.

4. The method of claim 3, further comprising
responsive to separating the audio from the video of the media, displayed, by one or more processors, the lyrics of the audio on the video being displayed on the second device.

5. The method of claim 4,
responsive to displaying the lyrics of the audio on the video altering, by one or more processors, the lyrics to show which words are to be sung to match up with the audio of the media.

6. The method of claim 5, further comprising:
switching, by one or more processors, the language of the lyrics.

7. The method of claim 1, wherein connecting, by one or more processors, the first device with a second device is done through a radio frequency, by supplying, by one or more processors, the first device with radio frequencies accessible on the second device.

8. The method of claim 1, further comprising:
responsive to playing the media through an output of the second device, recording, by one or more processors, audio and video from the first and second device; and
storing, by one or more processors, the audio and the video from the first and second device on the first device.

9. A computer program product for transferring media from one device to another, the computer program product comprising:
one or more computer readable storage media and program instructions stored on the one or more computer readable storage media, the program instructions comprising:
program instructions to access media on a first device;
program instructions to connect the first device with a second device;
program instructions to transfer the media from the first device to the second device;
program instructions to modify the media on the second device; and
program instructions to play the media through an output of the second device.

10. The computer program product of claim 9, further comprising:
program instructions, stored on the one or more computer readable storage media, which responsive to accessing the media on the first device, alter the order of the media.

11. The computer program product of claim 9, wherein modifying the media on the second device separates the media into audio and video.

12. The computer program product of claim 11, further comprising
program instructions, stored on the one or more computer readable storage media, which responsive to separating the audio from the video of the media, display the lyrics of the audio on the video being displayed on the second device.

13. The computer program product of claim 12,
program instructions, stored on the one or more computer readable storage media, to display the lyrics of the audio on the video to alter the lyrics to show which words are to be sung to match up with the audio of the media.

14. The computer program product of claim 13 further comprising:
program instructions, stored on the one or more computer readable storage media, to, switch the language of the lyrics.

15. The computer program product of claim 9, wherein connect the first device with a second device is done through a radio frequency to supply the first device with radio frequencies accessible on the second device.

16. The computer program product of claim 9, further comprising:
program instructions, stored on the one or more computer readable storage media, which responsive to playing the media through an output of the second device, record audio and video from the first and second device; and
program instructions, stored the audio and the video from the first and second device on the first device.

17. A computer system for automated vehicle authorization, the computer system comprising:
one or more computer processors, one or more computer readable storage media, and program instructions stored on the one or more computer readable storage media for execution by at least one of the one or more processors, the program instructions comprising:
program instructions to access media on a first device;
program instructions to connect the first device with a second device;
program instructions to transfer the media from the first device to the second device;
program instructions to modify the media on the second device; and
program instructions to play the media through an output of the second device.

18. The computer system of claim 17, further comprising:
program instructions, stored on the computer readable storage media for execution by at least one of the one or more processors, which, responsive to accessing the media on the first device, alter the order of the media.

19. The computer system of claim 17, wherein modifying the media on the second device separates the media into audio and video.

20. The computer system of claim 19, further comprising
program instructions, stored on the computer readable storage media for execution by at least one of the one or more processors, which, responsive to separating the audio from the video of the media, display the lyrics of the audio on the video being displayed on the second device.
